(19) United States
(12) Patent Application Publication
(10) Pub. No.: US 2005/0243857 A1
(43) Pub. Date: Nov. 3, 2005

(54) Simultaneously routing data over multiple wireless networks

(75) Inventors: Christian Hofstaedter, Perkasie, PA (US); Christopher Bogdon, Cranberry Townplace, PA (US); Randy Ellison, Fogelsville, PA (US)

Correspondence Address: GREENBLUM & BERNSTEIN, P.L.C., 1950 ROLAND CLARKE PLACE, RESTON, VA, 20191, US

(73) Assignee: PADCOM, Inc., Bethlehem, PA (US)

(21) Appl. No.: 10/835,396

(22) Filed: Apr. 30, 2004

(51) Int. Cl. H04L 12/413

(52) U.S. Cl. 370/447

(57) ABSTRACT

A method manages the flow of packetized data over multiple dissimilar wireless networks. The method includes assigning a weight to each of the wireless networks, and allocating a portion of the packetized data to each network based upon the assigned network weights. Finally, the allocated data is simultaneously sent across the corresponding wireless networks.

### CROSS REFERENCE TO RELATED APPLICATIONS

The present application is related to U.S. patent application Ser. No. 10/084,049, filed on Feb. 28, 2002, entitled “Port Routing Functionality,” which is a continuation-in-part of U.S. patent application Ser. No. 09/652,009, filed on Aug. 31, 2000, entitled “Method and Apparatus for Routing Data Over Multiple Wireless Networks”, and also a continuation-in-part of U.S. patent application Ser. No. 08/932,532, filed on Sep. 17, 1997, now U.S. Pat. No. 6,418,324, entitled “Apparatus and Method for intelligent Routing of Data between a Remote Device and a Host System,” which is a continuation-in-part of U.S. patent application Ser. No. 08/456,860, now U.S. Pat. No. 5,717,737, entitled “Apparatus and Method for Transparent Wireless Communication Between a Remote Device and a Host Systems” the contents of which are expressly incorporated by reference herein in their entireties.

The present application is also related to U.S. patent application Ser. No. 10/374,070, entitled “Prioritized Alternate Routing Functionality,” filed on Feb. 27, 2003, the content of which is expressly incorporated by reference herein in its entirety.

### BACKGROUND OF THE INVENTION

1. Field of the Invention

The present invention relates to the field of wireless communications. More particularly, the present invention relates to simultaneously routing data over multiple wireless networks regardless of the type, format or addressing of the wireless networks.

2. Background Information

Within the last decade, wireless networks have become integral to the day-to-day activities of mobile workers. Most organizations have realized the tremendous cost savings of using wireless networks by increasing worker productivity. In many cases, wireless networks have also proven to help reduce costs and increase the types of services provided by companies to their customers.

Wireless carriers have spent billions of dollars building out new third generation networks like GPRS, EDGE, 1xRTT, and 1xEvDO. 802.11 Wireless LANs are being proliferated around the world. Finally, there exist private RF networks like RD-LAP, EDACS, and conventional or trunked networks which are being used by millions of utility and public safety workers throughout the world.

Existing patents, such as U.S. Pat. No. 6,198,920, entitled “Intelligent Routing of Data between and Remote Device and a Host System” and U.S. Pat. No. 6,418,324, entitled “Apparatus and Method for Transparent Wireless Communication between a Remote Device and a Host System”, the disclosures of which are expressly incorporated by reference herein in their entireties disclose improved simultaneous utilization of multiple networks. In these systems, users can seamlessly roam between dissimilar networks. Therefore, as a mobile worker moves out of range of the primary network, the worker can continue to communicate over a secondary wireless network.

Solutions created for seamless roaming between dissimilar networks have helped promote the adoption of wireless networks. Seamless roaming allows mobile workers to take advantage of different networks and minimize the limitations that may be associated with any one single network. As an example, since wireless LANs provide high bandwidth access over a small area and CDMA 1xRTT provides lower bandwidth over a wide area, mobile clients can be configured to automatically use both networks. When in range of the Wireless LAN, the clients will take advantage of the increased throughput, but when only in 1xRTT coverage they will take advantage of the larger coverage area.

While these types of solutions are very powerful for end-users and provide control over the wireless networks, there is a need for enhancements that provide administrators with even more control of the networks. How can multiple networks be used simultaneously for transmission of data traffic? An enhancement like this would provide applications with the ability to use multiple networks as a single network. Therefore, the administrators could add rules and restrictions to make each separate and dissimilar network, operate as a single channel.

The immediate benefit of such a solution is increased throughput of the overall communication. For example, if a user were using a 19.2 Kbps network and a 28.8 Kbps network, simultaneously accessing the networks would produce a single channel of roughly 4× Kbps. However, the ability to manage multiple flows dynamically is a complex process due to issues surrounding wireless networks. Since wireless network coverage changes, a system must allow for automatic recovery when the network changes. In addition, since wireless networks usually have different transmission protocols, a system must be able to manage the different protocols and transmission characteristics of the network while maintaining sessions over the different networks.

Another indirect benefit of this solution is increased security of the transmissions sent through the networks. Since wireless networks use public airwaves for transmissions, most transmissions can be overhead. Encryption and other Virtual Private Network (VPN) services decrease the chance that the data can be intercepted and processed. However, there still exists the need to make data more secure. Therefore, by using multiple wireless networks, applications would be able to send different sequences of bytes over each network. Not only will a user have to decrypt the data traffic, they will have to capture the data traffic on both wireless networks at the same moment of time. Then the eavesdropper would have to understand the distribution of the data traffic through the multiple networks. Transmitting via multiple networks would virtually eliminate the possibility of capturing the data sent through the networks.

However, current systems do not provide this capability. Therefore, there is a need for using multiple wireless networks simultaneously to increase the security of the transmissions. This system should be able to dynamically build the network streams and dynamically manage the flow of data across the multiple networks.

Therefore, a need exists to manage communications over multiple wireless networks simultaneously to mobile devices. Moreover, a need exists for a system to address using multiple networks simultaneously when the networks are dynamically changing on a regular basis. In addition, there exists a need to maintain a single mobile host identity while applications are using multiple networks. Finally, a need exists for a system to provide an extra layer of security by sending packets over multiple wireless networks transparent to the end user, application, or network infrastructure involved.

### SUMMARY OF THE INVENTION

In view of the foregoing, the present invention is directed to using multiple networks, both wireless and wireline, for simultaneous communications while maintaining a static mobile host identity. The present invention, which may be embodied as multipathing, allows a mobile data user to simultaneously and transparently communicate over multiple wireless networks to a local area network or other mobile hosts using multiple networks at the same time or applications on the local area network can communicate outbound over the multiple wireless networks to the mobile clients.

According to an aspect of the present invention, a method is provided for managing flow of packetized data over multiple dissimilar wireless networks. The method includes allocating a portion of the packetized data to each network; and simultaneously sending the allocated data across the corresponding wireless networks.

According to an aspect of the present invention, the flow of packetized data over multiple dissimilar wireless networks is managed by assigning a weight to each of the wireless networks, and allocating a portion of the packetized data to each network based upon the assigned network weights. The allocated data is simultaneously sent across the corresponding wireless networks.

The entire packets may be allocated to each wireless network based upon the assigned network weights. Alternatively, a portion of each packet may be allocated to each wireless network based upon the assigned network weight. In this case, a network packet is associated with each network and the portion of each packet is allocated to the network packet associated with the designated network.

A rule describing the allocation may be encoded in the allocated data. Moreover, the allocating may be sequential, random, or alternating.

In one aspect, a loopback control packet is sent across each network to determine a latency of each network. Based upon the determined latency of each network the weights are assigned.

In another aspect, when the allocated data cannot be sent across the corresponding wireless networks, the data is not allocated and is sent over a single network.

In one embodiment, multiple multipath groups are defined, each group including multiple wireless networks. In this embodiment, a weight is assigned for each of the wireless networks in a selected group. Moreover, the data is allocated to each network in the selected group, and the allocated data is sent across the corresponding wireless networks in the selected group.

In yet another embodiment, packet criteria associated with a rule are defined. Then, each packet of the data is compared with the defined criteria. When the packet matches the criteria, the packet is allocated to one of the networks based upon the associated rule. When the packet does not match the criteria, the packet is sent without allocating the packet.

The features described above may be embodied as object code recorded on a computer readable medium. The features may also be part of a process for managing the flow of packetized data across dissimilar networks. Moreover, the features may be part of a system including a multipath component and a router.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 illustrates a general overview of using multiple wireless networks for increasing the throughput of communications, in accordance with an aspect of the present invention;

FIG. 2 illustrates a general overview of using multiple wireless networks for increasing the security of the data, in accordance with an aspect of the present invention;

FIG. 3 illustrates a schematic block diagram of the various components of a multipathing system;

FIG. 4 illustrates a block diagram that depicts software components, in accordance with an aspect of the present invention;

FIG. 5 illustrates an exemplary configuration screen, according to an aspect of the present invention;

FIG. 6 illustrates an example of using the network weights to calculate the distribution of data to each network, according to an aspect of the present invention;

FIG. 7 shows an exemplary loopback control packet, according to an aspect of the present invention;

FIG. 8 shows an example of the internal map data Structure used to store data packets, according to an aspect of the present invention; and

FIGS. 9A and 9B show an example of encoding a random distribution of bytes within a multipath transmission, according to an aspect of the present invention.

### DETAILED DESCRIPTION

Multipathing provides a mobile device with the ability to communicate over multiple networks simultaneously. Simultaneously preferably means during the same period of time or about the same period of time. The flexibility of the invention facilitates the ability to combine any number of networks together to form a single virtual networking link. Once the single virtual networking link is established, any application can transparently send data across the dissimilar wireless networks. Multipathing will automatically manage the flow of data through the different networks.

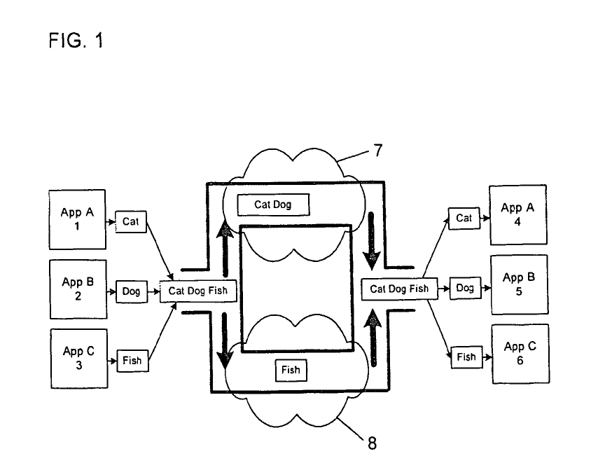

There are at least two uses for multipathing. One use is for increasing the speed of a communication. FIG. 1, shows an example of using multipathing to increase the overall bandwidth through a combination of wireless networks 7, 8. The first network 7 could be a GPRS network, and the other network 8 could be a CDMA 1xRTT network. In this example, applications 1, 2, 3 on the mobile side are attempting to send data packets (Cat, Dog, Fish) to applications 4, 5, 6, on the host side via two networks 7, 8. In FIG. 1, two packets (Cat, Dog), which originate from applications A and B (1, 2) respectively, are sent via a first network 7, and one packet (Fish), which originates from application C (3), is sent via the other network 8.

Using two networks together provides a combined throughput roughly equal to the summation of the speed of each wireless network minus the control packet overhead. As an upper bound, the maximum throughput would be the summation of the individual throughputs of each network. The overhead of the system is minimal so the maximum amount of bandwidth is available for data communications. The multipathing system can decide how to best utilize the aggregated networks to maximize the throughput. To further optimize data transmissions when the multipath system receives multiple outbound packets, it attempts to batch the packets together to utilize as much bandwidth as possible and send them among the networks based on criteria including the performance of the network.

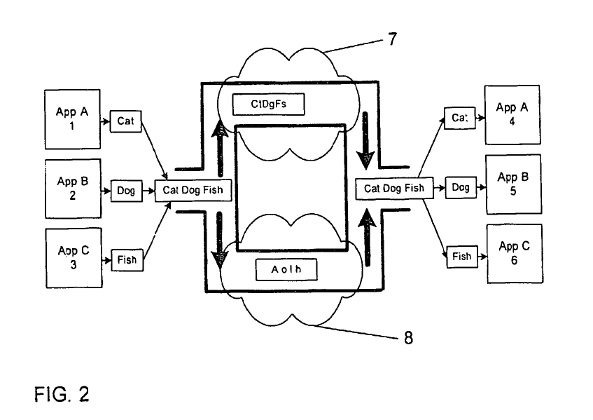

A second use for multipathing is to provide higher security for the data flowing through the networks. FIG. 2, shows an example of using multipathing to increase the security of data through two networks 7, 8. In this example, three applications 1, 2, 3, are sending data (Cat, Dog, Fish) to the host applications 4, 5, 6 via two networks 7, 8. In this case, however, the multipath system splits each packet on a byte-by-byte basis and sends a portion of each packet over each network based upon weighting assigned to the networks. In this example, the first and last bytes of the Cat packet, the first and last bytes of the Dog packet and the first and third bytes of the Fish packet are sent via the first network 7. The second byte of the Cat packet, the second byte of the Dog packet, and the second and fourth bytes of the first packet are sent over the other network 8. The multipath system then reassembles the bytes at the receiving end and forwards the reassembled packets to the appropriate applications 4, 5, 6.

Even though each individual network has its own security methods, using two networks to alternate data traffic through the networks increases the overall security of the data. Intercepting users will have little probability of recreating the packets unless they intercept the actual packets over both networks simultaneously and understand the breakup of the data through the different network. This functionality, combined with features like end-to-end encryption, digital signatures, hashing and dynamic encryption keys, dramatically increase the difficulty of recreating any data streams.

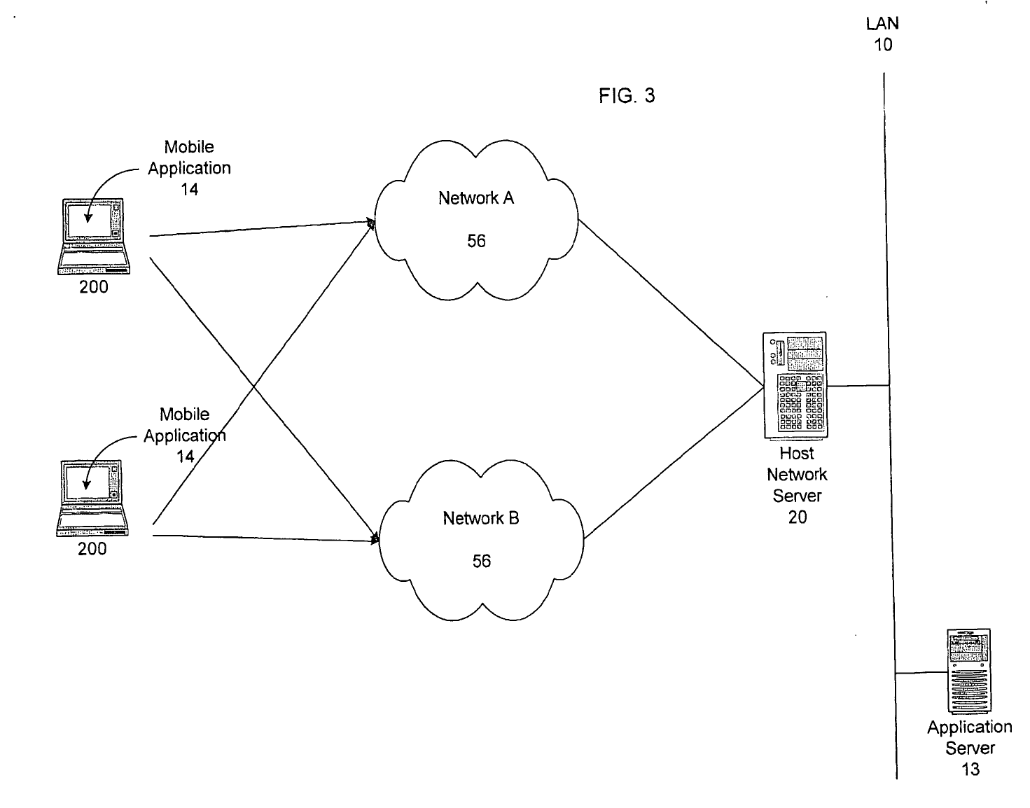

FIG. 3 shows an overall system diagram including a Host Network Server 20 acting as an access point to a local area network (LAN) 10, multiple mobile devices 200, at least one host application on an application server 13 on the LAN 10, at least one mobile application 14 on the mobile devices 200, and multiple networks 56. The multipath system is installed on both the mobile devices 200 and the Host Network Server 20. The flexibility of the design allows the multipathing system to be embedded within the mobile devices 200, or embedded within a hardware router (not shown) that may be connected to the mobile devices 200.

The application 14 on the mobile device 200 and the application residing on the application server 13 can be firmware or executable code created from source code that allows for network communications between the mobile client 200 and the LAN 10. If the mobile devices 200 are standard mobile computers, then exemplary applications include database or client-server applications, messaging or dispatch applications, web browser clients, file transfer applications and email clients. If the mobile devices 200 are not standard mobile computers, then exemplary applications may include firmware that takes pictures and streams the data, reads sensors and sends readings or receives data from a host application to control a device.

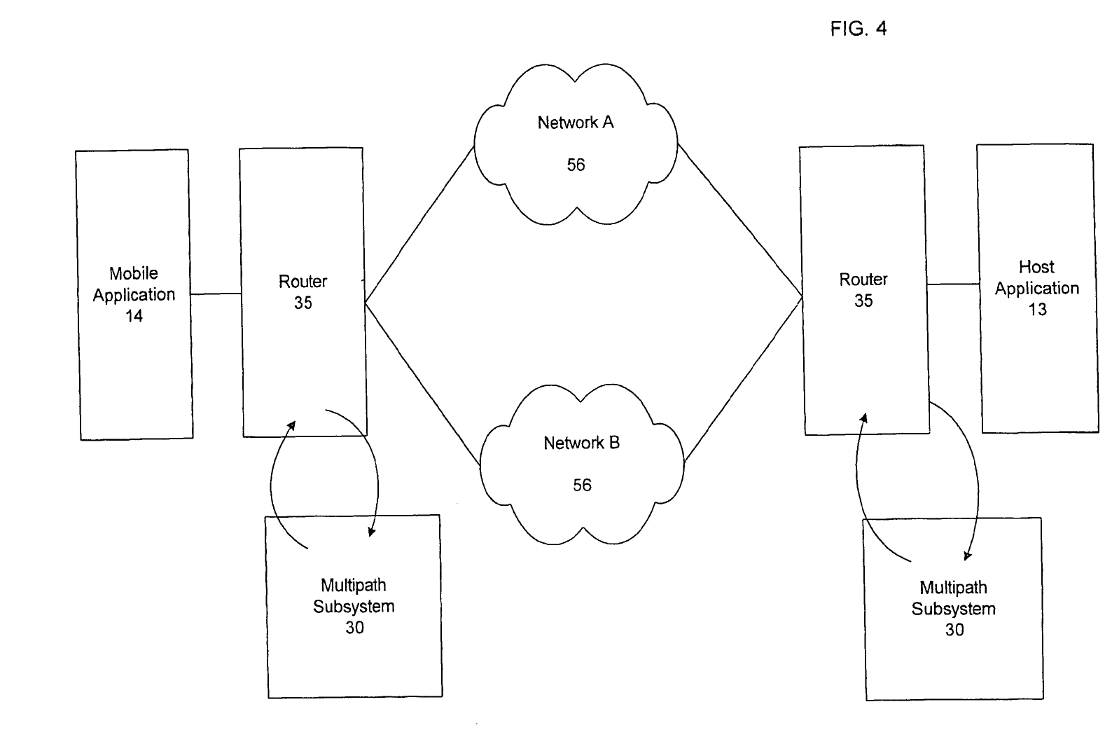

Multipathing is normally used in con unction with a wireless router. An exemplary router is described in U.S. Pat. Nos. 6,198,920 and 6,418,324 discussed above, the disclosures of which are expressly incorporated by reference herein in their entireties. FIG. 4 shows an example of communications between a router 35 and the multipath system 30. The router 35 can operate as a standard router; however, if certain traffic is required to be sent through the multipath system 30, then the data can be forwarded to the multipath system 30. The system also includes a mobile application 14 and a host application residing on an application server 13. The multipath system 30 communicates with the router 35 by accepting packets from the router and then sending packets back to the router 35. Therefore, when packets flow through the router 35, the router 35 can decide whether the data should be sent through the multipath system 30. The router 35 passes the data to the multipath system 30 for processing. Once the multipath system 30 finishes processing the data for transmission over the multiple networks 56, the multipath system 30 then passes the data back to the router 35 for eventual delivery over the networks 56. The communication between the router 35 and the multipath system 30 is via the well known IPC (inter-process communication).

The multipath system should understand when networks go in or out of range. This functionality is described in previous patents like U.S. Pat. Nos. 6,198,920, and 6,418,324, discussed above, the disclosures of which are expressly incorporated by reference herein in their entireties. This network status information is important for the multipath system since it is required to dynamically change its multipath behavior in response to dynamic changes of the network status.

Since the multipath system resides on the sender (e.g., Mobile Device) and the receiver (e.g., Host Network Server), each multipath system is responsible for both processing outbound multipath traffic as well as receiving inbound multipath traffic. Since the Host Network Server is responsible for multiple mobile devices, a one-to-many relationship exists. Therefore, each mobile client communicates with a single Host Network Server. The Host Network Server is then responsible for maintaining communications with the mobile clients. As an alternative embodiment, a multipath system that handles multiple connections can be located on the mobile clients as well as the Host Network Server. In this embodiment, any mobile client can create a multipath communications session directly with any other device.

The multipath system requires a configuration interface to provide control to system administrators to alter the behavior of the multipath system. In one embodiment, this configuration interface is located on each system that includes the multipath system. In an alternative embodiment, the configuration is only entered on the Host Network Server, and the mobile clients learn the configuration through the networks. This type of system has the advantage of reducing and centralizing the configuration required for the multipath system. The configuration functionality described below will be located on the Host Network Server.

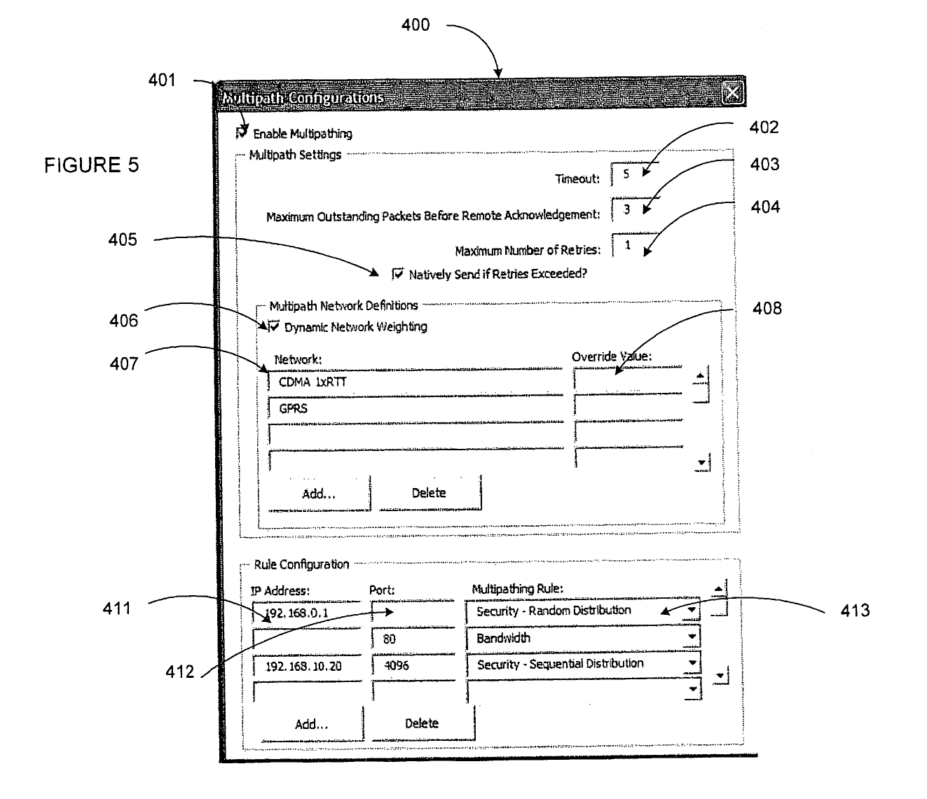

If the operating system on the Host Network Server provides a graphical user interface, the configuration can be performed using a graphical application residing on the Host Network Server. One exemplary type of configuration interface 400 is depicted in FIG. 5. If the multipathing software is installed on a device without a graphical user interface, then some other means will be required to receive the multipath configuration. An example is a configuration interface that receives configuration packets at a UDP port over the networks or accepts configuration via a downloaded file.

As shown in FIG. 5, the user will have an option 401 of enabling or disabling the multipathing functionality. If the multipathing is disabled, then data packets will be routed as normally defined by the system thereby bypassing the multipathing functionality. In the example shown in FIG. 5, the multipath functionality is enabled.

The configuration may also have the following parameters, however, other parameters may be included to streamline or offer further functionality to the multipathing system:
Timeout 402—The timeout value specifies the amount of time required to wait before a selective acknowledgement is sent. In the example shown in FIG. 5, the value is set to five.
Maximum Outstanding Packets before Remote Acknowledgement 403—The multipathing functionality can require positive acknowledgements from the receiving side after packets are sent. This parameter adjusts the member of packets that will be sent from the sender to the receiver before a selective acknowledgement is required. In the example shown in FIG. 5, the value is set to three.
Maximum Retries 404—This parameter specifies the maximum number of retries allowed before a client will time out. In the example shown in FIG. 5, the value is set to one.
Natively Send If Retries Exceeded 405—This parameter specifies the behavior of the system once the maximum retries have expired. If the system has unsuccessfully attempted to resend a packet (one time in the example shown), the router sends the packet without employing the multipath functionality when the box is checked (as shown in FIG. 5). If the box is not checked, the packet will be discarded when the maximum number of retries has been exceeded.
Defined Networks 407—This parameter specifies the networks that will be used for the multipathing configuration. The defined networks are referred to as the multipathing group. Therefore, the multipathing group refers to the different networks used for communication. In FIG. 5, two networks are part of the multipath group: CDMA 1xRTT, and GPRS.
Dynamic Network Weighting 406—The dynamic network weighting checkbox indicates whether the user manually assigns network weights or if the multipath system will dynamically determine the weights. If the dynamic network weighting parameter is set (as in FIG. 5), then the override value fields are disabled to restrict the user from centering any data.
Override Value 408—This parameter allows the user to statically define weighting factors for the networks when dynamic weighting is not used.

FIG. 5 also depicts an example where the administrator can define multiple multipath rules. These rules can be associated with a packet criterion. Therefore, if a packet is received that matches the criterion, the appropriate rule will be applied. Although FIG. 5 shows two types of criteria, IP address 411 and port number 412, any type of criteria can be used. Other non-limiting examples include packet size and protocol type. For each set of criteria, a rule type is configured.
Rule Type 413—This parameter specifies the type of rule controlling the routing. There are currently four rule types: bandwidth, security with alternating distribution, security with random distribution, and security with sequential distribution. This rule type field will specify the behavior of the multipath system on the packet depending on the user requirements. For example, in the first row, the IP address 192.168.0.1 is specified. Thus, any packets matching that IP address will be routed with the security—random distribution rule. Similarly, any packets matching port 80 will be routed according to the bandwidth rule, and any packets matching port 4096 AND IP address 192.168.10.20 will be routed according to the security—sequential distribution rule.

The above example presents an example of a multipath configuration for certain data traffic based upon some type of criteria. Therefore, data matching the specified criteria would flow through the multipath system. This example shows the multipathing functionality combined with a solution like the Port Routing functionality as disclosed in U.S. patent application Ser. No. 10/084,049 to Whitmore et al. filed on Feb. 28, 2002, the disclosure of which is expressly incorporated by reference herein in its entirety. Using this combination, system administrators can add multiple configurations for controlling the data flowing through the system. For example, the administrator can specify that web browser traffic (i.e., traffic originating from a port associated with web browser applications) can use one multipath rule (e.g., bandwidth); while a public safety dispatching application can use a different multipath rule (e.g., security). Although multiple configurations have been described, a single configuration for all traffic is also contemplated. Furthermore, although not shown in FIG. 5, an additional column (similar to column 413) could be provided so that specific data is associated with a multipath group, in addition to a multipathing rule.

The multipath system exists on both the mobile client and the Host Network Server so that the multipath system installed on the mobile client communicates directly with the multipath system installed on the Host Network Server. In addition, each multipath system processes both inbound and outbound traffic. Therefore, each end of the relationship understands how to send packets via the multipathing system and how to receive packets that were already sent through the multipath system. One method of viewing this relationship is the multipath system creates the multipath capable traffic for outgoing data received and then recreates the original data for incoming multipath traffic.

The multipath system can provide four different functions:
Network Measurements
Packet Queuing
Transmission Control
Loss Tolerance

Each of the above four will be discussed below in more detail.

Network Measurements

The multipath system understands the characteristics of all networks currently used for multipath communications. There are two main requirements for communicating between multipath systems. The multipath system is required to know which wireless networks are part of the user-defined multipath groups and is also required to understand whether the networks are in-range and active. To understand the network characteristics, i.e., whether the networks are in range, the multipath system can receive the information from the router or it can receive the information directly from the networks.

Therefore, communicating with the router will allow the multipath system to determine if the networks coverage or status dynamically changes. One such method of determining the information is by receiving unsolicited notifications from the router. Therefore, as the networks dynamically change, these notifications are passed to the multipath system.

Once the multipath system understands the networks and if they are active, the multipath system assigns a weighting value to each network. The weighting values are numbers allowing the multipath system to specify the amount of data that would flow through each network. The weighting values are only meaningful within a multipath group. Therefore, if a multipath system includes two multipath groups, then there will not be any correlation between the weighting factors in two different multipath groups.

The are many algorithms to assign weighting factors to the networks, and not all options will be discussed. One method is to statically identity the weighting values of the networks within the configuration utility. In this case, weighting values are entered by the administrator to identify, the weights associated with each of the wireless networks. The weights are based upon how much traffic the administrator wants to How through each network in the overall multipath group.

For example, if the administrator wants 25% of the traffic to flow through network one and 75% of the traffic to flow through network two, then the weights will be one for network one and three for network two.

In addition, the multipath system can dynamically determine the weighting values from the packet flows across the networks. To assign the weighting values according to this method, the multipath system examines the latency characteristics of the network.

A method is now described for dynamically determining the networks weights based upon the latency of the individual networks. If the administrator chooses to dynamically assign the weighting values of each network, then the multipath system determines these values. The multipath system determines the latency of the networks by sending and processing loopback control packets. After the multipath system receives and processes the loopback control packets, a numerical value is determined to represent the latency through the network. For example, a first wireless network (network A) may be calculated to have a latency of 100 ms. In addition, a second wireless network (network B) may be calculated to have a latency of 150 ms. Once these two numeric values have been determined, a ratio is used to derive the actual weighting values. The following formula can be used to determine the ratio:

$${r}_{i} = ( \frac{{l}_{i}}{{\sum }_{x = 1}^{n} {l}_{x}} ) * 100 \qquad ( 1 )$$

where
   lᵢ represents the latency of networkᵢ
   rᵢ represents the ratio calculated for networkᵢ and
   n represents the number of networks

In this, network A's ratio is four using formula (1). That is, 4=[100/(100+150)]*100. In addition, network B's ratio is six using formula (1), i.e., 6=[150/(100+150)]*100. Once these ratios are calculated, they will be arranged in descending order (from highest to lowest). Then, the individual networks will be listed in ascending order according to their latency value (lowest latency first, i.e., fastest network first). Finally, the first network in the network list is associated with the first ratio in the ratio list, the second network in the network list is associated with the second ratio in the ratio list, etc., to produce the weighting values for each network. In this example, the first network has the lowest latency (i.e., a latency of 100 ms) and is therefore assigned the highest ratio (6) as its weight.

Although the description discusses using a single method for multipath groups (i.e. static weights or dynamic weights), alternative embodiments can use multiple methods within a single multipath group. The algorithm defining the weighting values will become more complex, but the overall multipath system will still function as described.

The static method of data collection has at least one advantage in that users can specify that a single network should get the majority of data traffic, even though it may not be the fastest. If a particular network is more secure but slower than a less secure faster network, the user places a higher weighting factor on the slower network. Therefore, the user can apply the weights to make decisions on factors other than speed, e.g., network security.

While the static scenario provides the administrator with great flexibility, it is generally not as efficient as a dynamic configuration. For example, wireless network performance changes dynamically because of the movement of the mobile device. Therefore, especially with wireless networks, the network characteristics chance and the dynamic method would be able to compensate for the changes since it will dynamically detect the changes in network latency over time.

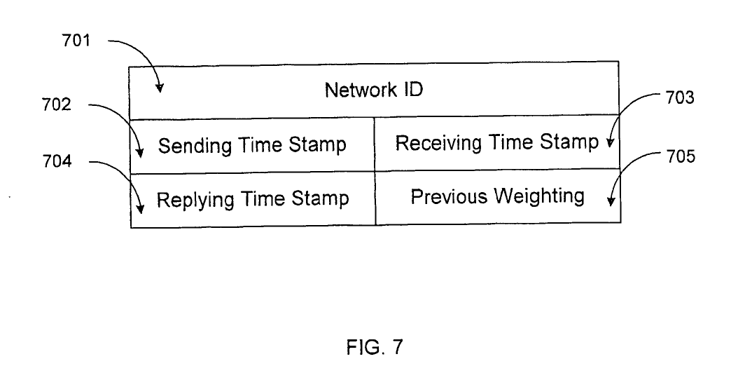

To support the dynamic collection of network latency characteristics the multipath system is responsible for generating loopback control packets. An exemplary embodiment of the loopback control packet is depicted in FIG. 7. The loopback control packets can be generated by either side of the multipath system, and may include a network ID 701 and the following information:
Sending Timestamp 702 This parameter specifies the timestamp of when the sender multipath system sent the loopback control packet.
Receiving Timestamp 703—This parameter specifies the timestamp of when the receiver multipath system received the loopback control packet.
Replying Timestamp 704—This parameter specifies the timestamp of when the receiver multipath system replied to the loopback control packet.
Weighting Factor 705—The weighting factor specifies the current weighting value for the particular wireless network.

The multipath system generates loopback control packets at various intervals throughout a communications session. Loopback control packets are sent independently through the various networks. Their frequency will depend upon the performance and the frequency of the data packets already flowing through the system in both directions. For example, as a performance optimization, if there are active transmissions being sent through the system, then the loopback control packets can be embedded at the end of existing transmissions. This will leverage existing network traffic for combining control functionality through the wireless networks. Alternatively, the loopback control packets can be sent on their own.

Queuing

The multipath system stores all inbound and outbound data packets that it received. In one embodiment of the invention, the multipath system receives the raw packets from the router, i.e., the packets created by either the mobile applications or the host applications. When a packet is received by the multipath system, it also receives the rule identifier for the packet via IPC. This rule identifier indicates the rule to be used to process the data. When the multipath configuration initially starts up, the actual rules can be shared with all mobile devices registered with the multipath system. In addition, the rule identifier is embedded in the packet sent over the network so the receiving multipath system can process the received packets accordingly.

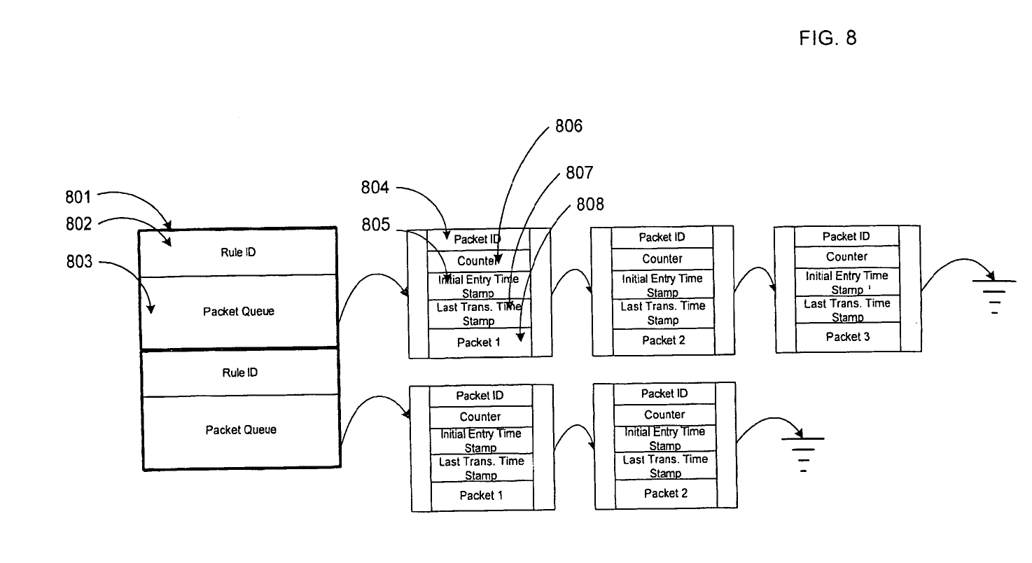

The multipath system stores each packet received in a map data structure or more specifically a map of queues. A map is a data structure object that contains a list of key/value pairs. A map cannot contain duplicate keys, and each key can map to one value only. While other well-known data structures, like arrays, stacks, queues, or linked lists can be used, a map provides the best performance for the type of functionality required by multipathing. One embodiment of the data structure is shown in FIG. 8. The map 801 is keyed off the rule that was applied and therefore stores a rule ID 802. In each map location, is a structure of various pieces of data. The structure will be a queue 803 of data objects related to the multipathing packets. FIG. 8 shows five types of data in each element of the map data structure:
Packet ID 804—This entry stores a unique packet ID value of each packet that is sent through the multipath system.
Data Packet 808—This entry stores the raw data packet received by the multipath system from the router.
Transmission Counter 806—This entry stores the number of transmission attempts for the data.
Initial Entry 805—This entry stores the initial system time stamp when the packet was initially received by the multipath system.
Last Transmission 807—This entry stores the system time stamp of the last transmission attempt.
   Transmission Control

The transmission control function is responsible for transmitting the packets to the receiver according to the multipathing rules. When the multipath system is ready to transmit packets, the transmission control function begins by retrieving the items entered into the queue data structure within the map tracking structure. Upon retrieving the packets, it begins to process the packets according to the rule associated with the packets.

The packets will be allocated to the designated networks based upon the specified weighting factor of the individual networks at the current time. For example, if network A is assigned a weight of one, and networks B is assigned a weight of three, then for every four packets received one will be assigned to network A and three will be assigned to network B. In the previous example if the multipath system received eight packets, then two packets would be allocated to network A and six packets would be allocated to network B. In addition, the multipath system accounts for the size of the packet to further distribute the packet across the networks.

If the rule is set to security distribution, then the weighting values would be used to identify how a packet would be broken up between multiple network packets. A packet is split if the rule associated with the packet was set for multipath security. There are three main configurations for the security control: alternating, random and sequential distributions. In the alternating configuration, the multipath system alternates each byte across different packets corresponding to the different networks. For example, in a two network configuration with equal weights between the networks, all odd bytes will go over network A and all even bytes will go over network B. In the random configuration, the individual bytes are randomly distributed across the different networks. Finally, in the sequential distribution, the bytes will be distributed across the networks according to the weighting assigned to the networks. In this example, if network A has a weight of two and network B has a weight of one, then a 750-byte packet will be broken as follows:

| Bytes | Network |
|---|---|
| 1-500 | Network A |
| 501-750 | Network B |

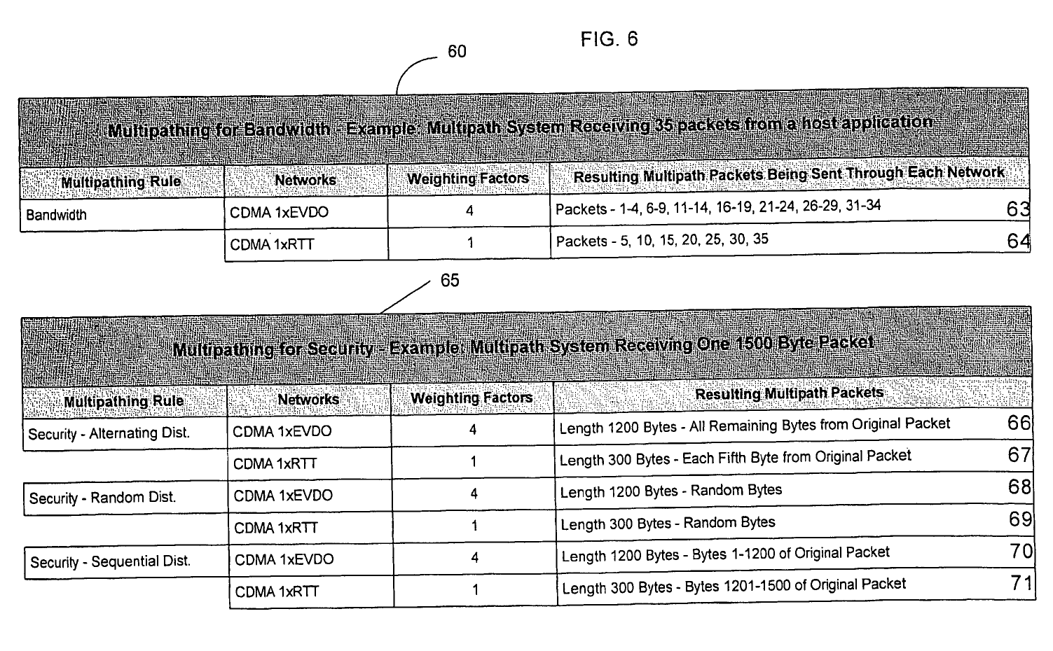

FIG. 6 shows examples of how the multipath system distributes packets over the different networks. The first example 60 shows a multipath system configured for bandwidth allocation. In this example shown, the multipath system receives 35 packets from a host application. Based upon the weighting factors of four and one, the multipath system distributes four packets through the CDMA 1xEVDO network and one packet through the CDMA 1xRTT network. The resulting packet distribution sends packets 1-4, 6-9, 11-14, 16-19, 21-24, 26-29, and 31-34 through the CDMA 1xEVDO network, as shown in row 63. Packets 5, 10, 15, 20, 25, 30, and 35 are sent via the CDMA 1xRTT network, as shown in row 64.

FIG. 6 also shows an example 65 of packet distributions based upon security. In this example, the multipath system receives a single packet from the application, and the system is configured to use the same weighting factors as in the bandwidth example 60. Based upon the weights, the table displays how the multipath system creates the resulting packets based upon the security definitions. In the security alternating distribution rule, the resulting packet destined for the CDMA 1xRTT network is 300 bytes long and includes every fifth byte from the original packet, as seen in row 67. The resulting packet destined for the CDMA 1xEVDO network is 1200 bytes long and includes all remaining bytes from the original packet, as shown in row 66. If the security—random distribution rule is applied, the resulting packet destined for the CDMA 1xEVDO network is 1200 bytes long and includes 1200 bytes selected randomly from the original packet, as shown in row 68. The resulting packet destined for the CDMA 1xRTT network is 300 bytes long and includes 300 bytes selected randomly from the original packet, as shown in row 69. If the security—sequential distribution rule is applied, the resulting packet destined for the CDMA 1xEVDO network is 1200 bytes long and includes the first 1200 bytes from the original packet, as shown in row 70. The resulting packet destined for the CDMA 1xRTT network is 300 bytes long and includes the last 300 bytes from the original packet, as shown in row 71.

In all the examples, the multipathing system uses a maximum transmission unit (MTU) for each wireless network to create the multipath packets. The MTU setting specifies the maximum size packet that can be sent through the wireless network. Therefore, the MTU setting will specify the upper limit of the size of packets that will be created. Once all packets are created, they will be sent buck to the router module for transmission through the wireless networks.

Loss Tolerance

The loss tolerance function of multipathing provides a retrying mechanism through the multipath system to ensure that data is sent successfully. There are many different well-known algorithms for processing acknowledgements, and various ones can be used for the multipath system. In a preferred embodiment, the Selective Acknowledgement (SACK) functionality, as defined in RFC 2018 “TCP Selective Acknowledgement Options” and RFC 2883 “An Extension to the Selective Acknowledgement (SACK) Option for TCP,” is employed. RFCs 2018 and 2883 are expressly incorporated by reference herein in their entireties.

An operating system background thread checks if any packet timeouts have expired. This thread looks at all previously transmitted packets to determine if the time since the last transmission attempt has exceeded the configured parameter. If the time has expired, then the multipathing system would resend the appropriate packets back to the router for delivery to the opposite side of the link. The system also increases the transmission attempts associated with the packet in the queuing data structure.

A packet expires if the transmission attempts associated with the packet are greater than that maximum transmission attempts set in the configuration. The actual configuration determines what will occur at this point. Either the packet will be discarded or it will be sent over a single network without regards to the multipath system. If the packet will be discarded, then a standard ICMP packet could be sent back to the application that sent the original packet.

If the packet distribution is based upon security, then there can be alternative embodiments that specify the behavior of lost packets. For example, if a data packet is split across multiple networks and one packet does not successfully cross the network, the multipath system can discard the packet all together. Alternatively, the remaining multipath fragment can be sent over the “good network”, or the entire original packet can be sent over the “good network”.

Process Flow

The process flow of data through the multipath system is now described.

Initialization

Upon startup of the multipath system, all data structures are initialized. There will bc at least two map data structures responsible for tracking the packets and the associated selective acknowledgements. One of the map data structures will be used to maintain inbound data traffic and the other data structure will be responsible for maintaining outbound data transmissions. After the data structure initialization occurs, the system will start the different operating system threads to manage the activities within the multipath system. The following threads may be started:
Network Measurements Thread—This thread will be responsible for receiving and processing updates to the weights of the wireless network. This thread will also be responsible for processing the loopback control packets.
Outbound Multipath—The outbound multipath thread will be responsible for listening to requests from the router for outbound data transmissions.
Inbound Multipath—The inbound multipath thread will be responsible for listening to requests from the router for inbound data transmissions.
Multipath Retry—The multipath retry thread will be responsible for checking any available queues to determine if a packet has to be retried.

Once the client side starts up, it will register with the appropriate multipath system on the Host Network Server by sending a registration packet to the gateway. This registration packet alerts the Host Network Server that the client multipath system is registration and ready for processing. Once the host multipath system receives the registration packet, it will send a registration acknowledgement back to the mobile multipath system. The host multipath system will also send the configuration rules. This process allows the multipath configuration to be specified only on the host side while the corresponding mobile sides synchronize with the host for configuration the preferred configuration, the route registration acknowledgement is expanded to contain the conflagration data. However, in an alternative embodiment the host network server may send is additional packet to provide the configuration data. In addition to the configuration, the multipath systems will also exchange the time stamp of the devices running the multipath Systems for purposes of benchmarking latency characteristics.

The actual multipath system will not be fully started until it receives a positive acknowledgement from its counterpart multi path system. The host side of the multipath system starts up in a similar manner to the client side but in the current embodiment, it will not send any registration messages. If during the multipath communication sessions the system administrator changes or updates the configuration, then the host network server may send out unsolicited configuration update packets to the mobile clients.

Network Measurements Thread

Upon initialization of this network, the thread will wait for requests from the outbound multipath thread for requests for network weights. The network measurements thread will communicate with The other threads in the system using a method of Inter/Intra-Process Communications (IPC). While the thread is idle, if there are any networks in the system that require dynamic updating via the loopback control packets, then when an internal timer expires for the wireless network, the network measurements thread will send a loopback control packet to the router for delivery to the other side of the multipath relationship. While the thread is idle, it waits for either a request from a thread requesting the network weight or it detects that a loopback control packet has been received.

If the thread receives a loopback control packet, then it will process the loopback control packet based upon timestamps associated with the peer system. Once the latency of the network has been calculated by the thread, the thread will store the latency associated with the network, e.g., in an internal table. In addition, the network measurements thread will store the initial latency measurements of the different networks. In case the multipath system is unable to determine the network latency at a future time, it will use the stored initial measurement. Finally, the weight factor will be updated if a new weight factor is determined.

If the thread receives a request for a network weight, it will receive the request via IPC. Included within the request will also be a network ID. The thread will look into the internal storage table for the actual weight associated with that particular network. It will then retrieve the stored value and return it back to the caller via the IPC mechanism. In this embodiment, the weight for a single network is retrieved. However, if multiple multipath groups are created, then the configuration for an appropriate network can be retrieved for each multipath group.

Outbound Multipath Thread

Processing an outbound packet will now be discussed. The outbound multipath thread is responsible for processing outbound data that will be sent to the corresponding multipath system. The outbound multipath thread will minimally create outbound data packets and in alternative embodiments, other types of packets. The thread starts in an idle state by waiting for a packet from the router. When the router passes a packet to the outbound multipath thread, it also passes in various information:
Data Packet—This field will include the raw data packet that the multipath system will be required to send through the system.
Data Packet Length—This field will include the length of the data packet.
Rule Type—This field will contain the identifier to determine which multipath rule should be applied.

The outbound multipath thread may require other data. For example, when the multipath system sends a packet, it may combine multiple original packets together. If this is the case, then there may be a definition to determine where the individual packet boundaries are within the data packet. Therefore, when the data packet is processed on the opposite end, the system will be able to separate the individual packets. Combining many small packets together in one transmission is a useful optimization.

At this point, the outbound multipath thread will first determine the current weights of the networks associated with the group. The thread will send a message to the network measurements thread to retrieve the weights for the appropriate networks. If the network rule specifies bandwidth then the system will start assigning the packets to the networks based upon the network weights. For example, if the current rule provides for three networks and the weights are one, two, and three, then the outbound multipath thread will assign the first packet to network A, the second and third packets to network B and finally the fourth, fifth and sixth packets to network C.

In the case of the security rule, the outbound multipath thread will split the packet among multiple packets based upon these weights. If the current rule provides for three networks and the networks have weights one, two, and three, the outbound multipath thread will then create three new packets. The first packet will have the smallest size, the second will have a medium size, and the third will contain the largest fragment of the original packet.

The outbound multipath thread is also responsible for identifying the maximum size of the packets. The network MTU will first be used to identify the upper bound on the maximum size of the packets. Then the weights will be used to identify the distribution across the packets. For example, if the three networks have corresponding weights one, two, and three, and the original data packet received from the router is 1000 bytes, then 166 bytes will be allocated to packet one, 334 bytes will bc allocated to packet two and finally 500 bytes will be allocated to packet three, assuming the MTUs are not exceeded.

Continuing in the case of the security rule, the outbound multipath thread then identifies what type of security rule is associated with the data packet. If the rule is alternating distribution, then the outbound multipath thread places the first byte in network A's packet, second byte in network B's packet and third byte in network C's packet. The thread continues this sequence until all new packets are filled with the data according to the network weight calculation and MTU settings.

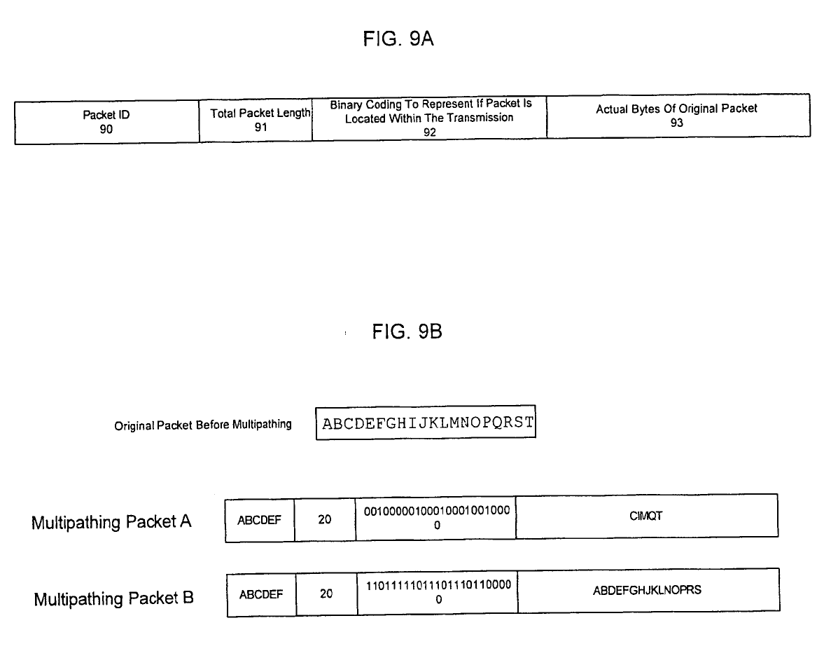

If the rule is random distribution, then the multipath system places the bytes of the original packet in random patterns across the packets corresponding to the multiple networks. In this case, the thread also embeds the random sequence used for placing the bytes within the packet so the receiver multipath system can process the appropriate sequence. One method for embedding the random sequence is to embed extra fields within the data packet to specify the sequence. An example is presented in FIG. 9, discussed below.

Finally, if the rule specifies the sequential distribution of data, then the multipath system will break up the packets according to their weights. In the above example, with three networks each assigned weights one, two, and three, the first 166 bytes will be assigned to network one, the second 334 bytes will be assigned to network two and the final 500 bytes will be assigned to network three.

Once the packets are created, they are added to the map storage structure. During the insert, the thread also places a current timestamp on the packets and resets the retry counter to zero.

After the multiple packets have been created and entered within the queuing structure, they are placed within a new data packet with a CRC value embedded in the packet. This CRC value is a calculated checksum based upon the data in the packet. This CRC value is also used on the remote side to detect any errors in the transmission. The newly created data packet will then be sent to the router for delivery across the multiple networks to the receiving multipath system. Using the CRC check is only one method for detecting packet errors, other methods like hashing using MD5 can also be used.

Inbound Network Thread

Inbound data transmissions will now be discussed. The inbound network thread is responsible for processing any packets received from the transmitting multipath system. There are at least five main types of packets to be received.
Inbound Data Packets
Loopback Control Packets
Selective Acknowledgements (SACK)
Selective Negative Acknowledgements (SNACK)
Registration and Configuration Packets

Whenever the inbound network thread receives a loopback control packet, the inbound network thread sends the packet to the network measurement thread, which calculates the latency through the network based upon the time stamps entered within the packet. The inbound network thread then receives the loopback control packet from the network management thread and returns it to the original sender.

Whenever an inbound data packet is received, the inbound network thread first determines if the packet is corrupted. It calculates the CRC of the packet and compares it to the CRC that was embedded within the packet. If the CRC check fails, then the multipath system discards the packet and sends a selective acknowledgement to request a retry of the packet.

If the CRC check of the packet was successful, then the multipath system determines if the packet is the start of a new multipath transmission or if the packet is part of an existing transmission. If the packet is the first packet of a transmission then the thread begins by allocating a data structure to keep track of the received packets. All future packets received that belong to the same multipath transmission are placed within the data structure for tracking as well.

If all the packets have been received correctly, then the inbound network thread acknowledges the sender with a selective acknowledgement. The inbound network thread then rebuilds the original data transmission based upon the rule encoded within the received packets. Once the inbound network thread rebuilds the data packet, it passes the newly rebuilt data packets to the router for delivery to the appropriate applications. Since the data packets are rebuilt, they look identical to the packets originally sent by the application on the opposite side even though they traversed different networks.

If all the packets have not been received correctly or the receiver has detected a pause in the data transmissions, then the receiver may send a selective acknowledgement to the sender to request the retransmission of the lost or missing packets.

Whenever a selective acknowledgement packet is received, the inbound network thread attempts to process the packet. One such method is responding to a query as to which packets have been received or not received. In this case, the sender asks the receiver which data packets are received correctly. The inbound network thread responds by acknowledging the data packets.

Finally, the inbound network thread can receive registration packets. If the registration packet has been received by the multipath system installed on the Host Network Server, then the inbound network thread registers the mobile system. In the response, the thread sends back to the multipath system a registration response including the complete rule definitions stored on the gateway. These definitions correspond to which rules are defined for multipathing.

If the multipath system is installed as a client, then receiving a registration packet triggers two main functions. Upon the successful receipt of the registration response, the multipath system immediately stores all the rule definitions within its own configuration. In addition, the receipt of the registration response completes the initialization routine for the multipath system. The multipath system can begin use for data transmissions.

Multipath Retry Thread

The multipath retry thread is responsible for retrying packets. If the system is a receiver (i.e., the multipath system is in the middle of receiving transmissions), then the multipath retry thread sends a selective acknowledgement to the sending system based upon the number of packets for each acknowledgement. The retrying methodology uses the value stored in the “Maximum Outstanding Packets Before Remote Acknowledgement” parameter in the configuration. If the sender has sent a number of packets greater than this value and not received an acknowledgement, then the multipath retry thread sends an SACK to determine which packets need to be resent.

If a packet needs to be resent, then the multipath retry thread increases the current retry count stored in the map data structure. If the current retry count is greater than the “Maximum Retries” value stored in the configuration, then the thread attempts to cancel the packet. If the configuration has the “Natively Send if Retries Exceeded?” box checked, then the multi path retry thread rebuilds the original data packet and sends it back to the router for delivery without the multipath system. Therefore, the packet is sent as a regular data transmission without multipathing functionality.

If the current retry count is greater than the “Maximum Number Of Retries” value stored in the configuration and the “Natively Send if Retries Exceeded?” is not checked, then the packet is not sent. Instead, the thread alerts the router that the packet should be canceled and discarded. The router can cancel the packet in any way it determines necessary. In most cases, the cancel is implemented by sending back an ICMP message to the original application that sent the application, however, the router system may choose a different way of implementing the solution.

FIG. 9A shows an example of a packet format for binary encoding between the different networks with the security distribution. As noted above, when using multipathing for security, the user has the option of specifying the actual distribution of the individual bytes between the different wireless networks. Both sides of the multipathing system must be aware of this relationship (i.e., the sender must know how to encode the packet and the receiver must know how to decode the packet). FIGS. 9A and B illustrate an effective method for the sending multipath system to automatically encode the data distribution within its packet. Therefore, as the receiving multipath system receives this data packet, it is able to reconstruct the original data.

The encoding is implemented by using specific fields within the new data packet. The first field includes the packet ID 90 and the second field stores the total packet length 91. A “binary coding” field 92 contains a single bit for each byte within the original packet. Therefore, if the original packet is 100 bytes long, this field will be 100 bits long. If the bit is set to 1, then the byte at that packet position is contained in this packet, otherwise the data byte is encoded within a different packet.

Referring to the example shown in FIG. 9B, an original packet of 20 bytes is transmitted across two networks and network A has a weight of one while network B has a weight of three. The multipathing packet A has the third bit set to a one. This means that the third byte of the original data packet will be encoded within this packet. However, the first two bits are zero. These zeros represent the fact that the first two bytes are not encoded in this packet, but are encoded in another packet.

Finally, the last field 93 contains the actual data bytes. The best way to describe this field is to expand the example. As noted above, the third bit of multipathing packet A is set to a one, therefore the first byte of the actual bytes field 93 represents the actual data byte at that position (3) in the original packet. As another example, in multipathing packet B, bits one and two are set to a one. Thus, bytes one and two are in this packet and therefore, since the first two bytes are “A” and “B” then these bytes will be placed within the position of bytes one and two.

The above invention has been described with various algorithms for distributing data amongst multiple networks. While several exemplary methods have been described, the invention will provide flexibility so that any type of algorithm can be employed to distribute data amongst the multiple networks. Other methods that can be used include, but are not limited to specifying which bytes are associated with what networks and random association of rules with different packets.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for internet and other packet switched network transmission (e.g., IP version 4, IP version 6, UDP/IP, TCP/IP, ICMP), and wireless networking (802.11a, 802.11b, 802.11g, CDMA 1xRTT, CDMA 1xEVDO, GSM, CDPD, GPRS, EDGE, UMTS, R-D-LAP, SMR, LMR) represent examples of the state of the art. Such standards are periodically superseded by faster or more efficient equivalents having essentially the same functions. Accordingly, replacement standards and protocols having the same functions are considered equivalents.

1. A method for managing flow of packetized data over multiple dissimilar wireless networks, the method comprising:
allocating a portion of the packetized data to each network; and
simultaneously sending the allocated data across the corresponding wireless networks.

2. A method for managing flow of packetized data over multiple dissimilar wireless networks, the method comprising:
assigning a weight to each of the wireless networks;
allocating a portion of the packetized data to each network based upon the assigned network weights; and
simultaneously sending the allocated data across the corresponding wireless networks.

3. The method of claim 2, in which the allocating packetized data further comprises allocating entire packets to each wireless network based upon the assigned network weights.

4. The method of claim 2, in which the allocating packetized data further comprises allocating a portion of each packet to each wireless network based upon the assigned network weight.

5. The method of claim 4, in which the allocating further comprises associating a network packet with each network and allocating the portion of each packet to the network packet associated with the designated network.

6. The method of claim 2, further comprising encoding in the allocated data a rule describing the allocation.

7. The method of claim 4, in which the allocating is random.

8. The method of claim 4, in which the allocating is alternating.

9. The method of claim 2, further comprising sending a loopback control packet across each network to determine a latency of each network.

10. The method of claim 9, in which the assigning weights further comprises assigning weights based upon the determined latency of each network.

11. The method of claim 2, wherein when the allocated data cannot be sent across the corresponding wireless networks, sending The allocated data over a single network without allocating the packetized data.

12. The method of claim 2, further comprising defining a plurality of multipath groups, each group comprising a plurality of wireless networks,
wherein the assigning further comprises assigning a weight for each of the wireless networks in a selected group;
wherein the allocating further comprises allocating the data to each network in the selected group; and
wherein the sending further comprises sending the allocated data across the corresponding wireless networks in the selected group.

13. The method of claim 2, further comprising:
defining packet criteria associated with a rule;
comparing each packet of the data with the defined criteria;
when the packet matches the criteria, allocating the packet to one of the multiple networks based upon the associated rule; and
when the packet does not match the criteria, sending the packet without allocating the packet.

14. A system for managing flow of packetized data over multiple dissimilar wireless networks, the system comprising:
a multipath component that assigns a weight to each of the wireless networks, and allocates a portion of the packetized data to each network based upon the assigned network weights; and
a router that receives the allocated data from the multipath component and simultaneously sends the allocated data across the corresponding wireless networks.

15. The system of claim 14, in which the multipath component allocates entire packets to each wireless network based upon the assigned network weights.

16. The system of claim 14, in which the multipath component allocates a portion of each packet to each wireless network based upon the assigned network weight.

17. The system of claim 16, in which the multipath component associates a network packet with each network and allocates the portion of each packet to the network packet associated with a designated network.

18. The system of claim 14, in which the multipath component encodes in the allocated data a rule describing the allocation.

19. The system of claim 14, in which the multipath component generates a loopback control packet for sending across each network to determine a latency of each network.

20. The system of claim 19, in which the multipath component assigns weights based upon the determined latency of each network.

21. The system of claim 14, wherein packet criteria is associated with a rule; and
in which the multipath component compares each packet of the data with the defined criteria;
when the packet matches the criteria, allocates the packet to one of the multiple networks based upon the associated rule; and
when the packet does not match the criteria, the router sends the packet without the packet being allocated.

22. A computer readable medium storing a program for managing flow of packetized data over multiple dissimilar wireless networks, the medium comprising:
an assigning code segment that assigns a weight to each of the wireless networks;
an allocating code segment that allocates a portion of the packetized data to each network based upon the assigned network weights; and
a transmission code segment that simultaneously sends the allocated data across the corresponding wireless networks.

23. The medium of claim 22, in which the allocating code segment further comprises allocating entire packets to each wireless network based upon the assigned network weights.

24. The medium of claim 22, in which the allocating code segment further comprises allocating a portion of each packet to each wireless network based upon the assigned network weight.

25. The medium of claim 24, in which the allocating code segment further comprises associating a network packet with each network and allocating the portion of each packet to the network packet associated with the designated network.

26. The medium of claim 22, further comprising an encoding code segment that encodes in the allocated data a rule describing the allocation.

27. The medium of claim 22, in which the transmission code segment further comprises sending a loopback control packet across each network to determine a latency of each network.

28. The medium of claim 27, in which the assigning code segment further comprises assigning weights based upon the determined latency of each network.

29. The medium of claim 22, wherein when the allocated data cannot be sent across the corresponding wireless networks, the transmitting code segment sends the packetized data over a single network without allocating the data.

30. The medium of claim 22, wherein a plurality of multipath groups are defined, each group comprising a plurality of wireless networks,
wherein the assigning code segment further comprises assigning a weight for each of the wireless networks in a selected group;
wherein the allocating code segment further comprises allocating the data to each network in the selected group; and
wherein the sending code segment further comprises sending the allocated data across the corresponding wireless networks in the selected group.

31. The medium of claim 22, in which packet criteria is associated with a rule;
the medium further comprising a comparing code segment compares each packet of the data with the defined criteria;
when the packet matches the criteria, the allocating code segment allocates the packet to one of the multiple networks based upon the associated rule; and
when the packet does not match the criteria, the transmitting code segment sends the packet without allocating the packet.
